(19) United States
(12) Patent Application Publication
(10) Pub. No.: US 2011/0192316 A1
(43) Pub. Date: Aug. 11, 2011

(54) ELECTROLESS PLATING SOLUTION FOR PROVIDING SOLAR CELL ELECTRODE

(75) Inventors: Chia Wei CHOU, Ying-Go Town (TW); Su-Fei HSU, Ying-Go Town (TW); Michael LIU, Ying-Go Town (TW)

(73) Assignee: E-CHEM ENTERPRISE CORP., Ying-Go Town (TW)

(21) Appl. No.: 13/013,917

(22) Filed: Jan. 26, 2011

Related U.S. Application Data
(60) Provisional application No. 61/282,420, filed on Feb. 5, 2010.

(51) Int. Cl. C09D 1/00

(52) U.S. Cl. 106/1.22

(57) ABSTRACT

An electroless nickel plating solution for solar cell electrode, which comprises SiNₓ and Si patterned structure, is disclosed. The electroless plating solution of the present invention comprises: nickel ion; a reducing agent; a first chelating agent; a second chelating agent; and water. The electroless plating solution of the present invention has high selectivity between Si and SiNₓ and is harmless to the aluminum-based layer, therefore is suitable for being used in the fabrication of the electrodes of the solar cell.

### CROSS REFERENCE TO RELATED APPLICATION

This application claims the benefit of filing date of U.S. Provisional Application Ser. No. 61/282,420, entitled “Electroless Nickel Plating Solution For Solar Cell Electrode And Method Using The Same” filed Feb. 5, 2010 under 35 USC §119(e)(1).

### BACKGROUND OF THE INVENTION

1. Field of the Invention

The present invention relates to an electroless nickel plating solution and, particularly relates to an electroless nickel plating solution for solar cell electrode.

2. Description of Related Art

With the development of industrial technology, the serious problems that the whole world is facing today are the energy crisis and the environmental pollution. In order to solve the global energy crisis and to reduce the environmental pollution, a lot of efforts are being made on green energy, such as wind power and solar energy, to replace fossil fuel sources. In particular, the solar cell is one of the effective means, which can convert the solar energy into electricity.

Reference with FIGS. 1A to 1C, a process flow chart of providing an electrode of a conventional solar cell is shown. First, a semi-product of silicon substrate 1 is provided, in which the silicon substrate 1 comprises an n-type silicon layer 11 and a p-type silicon layer 12, and a silicon nitride layer 13 is formed on the n-type silicon layer 11. Besides, a recess 19 is formed in the surfaces of the silicon nitride layer 13 and the n-type silicon layer 11, wherein the recess 19 penetrates the silicon nitride layer 13. Then, as shown in FIG. 1B, a silver paste layer 15 is formed in the recess 19 of the n-type silicon layer 11 by a printing method, and an aluminum paste layer 14 is formed on the p-type silicon layer 12. Finally, as shown in FIG. 1C, nickel layers 17 and 16 are formed respectively on the silver paste layer 15 and the aluminum paste layer 14 by an electroplating method or an electroless plating method. In the prior arts, two transferring printing steps that forms a silver paste layer 15 and an aluminum paste layer 14, and an electroplating step or an electroless step are usually comprised in the forming of the positive/negative electrodes.

With regards to the preparation of electrodes of solar cells, in the U.S. Pat. No. 5,591,565, a method of fabricating a negative electrode of the solar cell is proposed, in which a silver paste is used. Also, in the US 2008/035489, a method of fabricating an electrode of the solar cell by electroplating is used, in which a silver layer is formed on a silver paste layer by an electroplating method, and therefore a negative electrode is formed. In the TW 2008/18526, a patterned positive electrode structure of the solar cell is disclosed.

In the US 2009/239330 (WO 2009/117007), a method of fabricating a solar cell by coating the silicon substrates with nano-particles is proposed, in which the electrode is made of a silver paste instead of being made by applying electroless plating on the surfaces of the silicon substrate.

It is well known that a silver paste, an aluminum paste, or a silver-aluminum paste can be applied to the manufacturing of the solar cell. For example, in the JP 2007/251609 (TW 2009/26210), US 2009/0126797 (TW200937451), and the US 2007/0215202 (TW200742098), the usage and the composition of the silver paste, the aluminum paste, and the silver-aluminum paste are detailedly described. However, since the cost of the silver paste is high, and the resistance of the glass powder and the polymers contained in the silver paste are both high (which may result in a high resistance of the electrode of the solar cell), the efficiency of the solar cell is reduced and the economical efficacy is lowered. Therefore, due to the low resistance of the nickel, it is proposed that nickel can be used to replace the silver paste in the forming of the electrode to lower the resistance and increase the efficiency of the solar cell.

The idea of using nickel for the manufacturing of the solar cell can be earlier seen in the U.S. Pat. No. 4,321,283, in which 640 g/L of nickel chloride and 40 g/L of ammonium fluoride is used in the nickel electroplating process for the surface of the silicone nitride-free solar cell silicon substrate to form electrodes.

In the US 2004/0005468, a method of fabricating an electrode of the solar cell is proposed, which comprises an activation step of the silicon substrate and a basic electroless nickel plating step.

In the WO 2009/070945, an illuminating method used for nickel electroplating to form the electrode of the solar cell is proposed, which is limited in the light source and therefore is inconvenient and slow compared with the method of the electroless plating.

According to the prior arts, no matter what kinds of acidic electroless plating solution (high temperature operated acidic electroless plating solution or low temperature operated acidic electroless plating solution) are used, acidic electroless plating solutions have no selectivity between silicon nitride and silicon, whereas it is possible for basic electroless plating solutions to have the selectivity between silicon nitride and silicon.

Having high selectivity between silicon nitride and silicon for the electroless plating solutions is important during the fabricating of the solar cells. If the selectivity between silicon nitride and silicon of the electroless plating solutions is low, nickel will be formed on the silicon nitride layer and therefore resulted in the reducing of the active area and the reducing of the photoelectric conversion efficiency.

When a conventional basic electroless plating solution is used to form nickel on the silicon of the patterned structure of silicon and silicon nitride of the solar cells, some problems may occur, such as the damage of the silicon layer and/or the undesired forming of the nickel on the silicon nitride.

Besides, in order to keep the efficacy and the lifespan of the basic electroless plating solution, a high temperature such as 85° C. is needed for a conventional basic electroless plating solution to work. However, the high temperature applied for a conventional basic electroless plating solution for the fabricating of the electrodes of the solar cells is harmful to the surface of the silicon nitride. Also, the increased reducing power of the electroless plating solution due to the high temperature applied may reduce the selectivity between silicon nitride and silicon, and result in the forming of the nickel on both the silicon nitride layer and the silicon layer.

If the surface of the silicon nitride is damaged, resulting in the loss of the hydrogen atoms, the passivation functions (relating to the electronics with defect and to the surfaces of the electronics) of the silicon nitride may be disturbed, and the photoelectric conversion efficiency of the solar cell may be lowered. In the U.S. Pat. No. 6,746,709 (TW 561629), the functions and the method for manufacturing the silicon nitride having hydrogen atoms are detailedly described. When some surface of the silicon nitride is undesirably plated with nickel, the light-receiving area in the solar cell may be decreased and thus the conversion efficiency of the whole solar cell may be lowered.

Accordingly, since a conventional electroless plating solution is unable to satisfy sufficient selectivity between silicon nitride and silicon, the required structure for solar cell, in which no nickel is plated on the surface of the silicon nitride while the surface of the silicon is electroless plated with nickel, is difficult to obtain by using a conventional electroless plating solution. Therefore, in the prior arts, although silver paste has low operability (i.e. workability) and costs high, it is selected without choice to form the negative electrode in the fabricating of the solar cells.

Therefore, it is desirable to provide an improved electroless plating solution for fabricating the electrodes of the solar cells to increase the photoelectric conversion efficiency of the solar cells, and lower the producing cost and simplify the manufacturing steps for the fabricating of the solar cells.

### SUMMARY OF THE INVENTION

The present invention provides a basic electroless nickel plating solution operated at low temperature, which is used to form an electrode of a solar cell having patterned structure comprising silicon and silicon nitride. The electroless nickel plating solution of the present invention comprises: (a) 4.5 g/L to 10.0 g/L of nickel ions; (b) a reducing agent; (c) 30 g/L to 60 g/L of a first chelating agent selected from the group consisting of citric acid, ammonium citrate, sodium citrate, potassium citrate, and a mixture thereof; (d) 5 g/L to 80 g/L of a second chelating agent; (e) 0.000 5 g/L to 0.002 g/L of a stabilizer; and (0 water, wherein the pH value of the electroless nickel plating solution is in a range of 7.0 to 10.0; the second chelating agent is one selected from the group consisting of: alkylol amine (i.e. alcohol amine), ethylene diamine, diethylene triamine, triethylene tetramine, and a combination thereof.

The basic electroless nickel plating solution operated at low temperature of the present invention has high selectivity between silicon nitride and silicon. Hence, nickel can be plated on the surface of silicon, and not plated on the surface of silicon nitride. When the electroless nickel plating solution of the present invention is applied on an aluminum layer to provide a positive electrode of a solar cell, the electroless nickel plating solution does not corrode the aluminum layer, and nickel can be plated on the surface of the aluminum layer. Therefore, the basic electroless nickel plating solution of the present invention is very suitable for forming electrodes of a solar cell, and a positive electrode and a negative electrode of a solar cell can be formed separately or simultaneously.

In order to achieve the purpose of electroless nickel plating on the surface of silicon without plating on the surface of silicon nitride, a low temperature process is necessary. Also, in order to achieve the purpose of performing the low temperature process, the sorts and the ratio of the chelating agents have to be adjusted properly to meet the requirement for start of the electroless nickel plating reaction. In addition, the sorts of the chelating agents may influence the lifespan of the electroless nickel plating solution.

According to the basic electroless nickel plating solution operated at low temperature of the present invention, the first chelating agent is preferably selected from the group consisting of: citric acid, ammonium citrate, sodium citrate, potassium citrate, and mixtures thereof. The second chelating agent is preferably selected from the group consisting of: alkylol amine (e.g. diethanol amine, triethanol amine), ethylene diamine, diethylene triamine, triethylene tetramine, and mixtures thereof.

According to the basic electroless nickel plating solution operated at low temperature of the present invention, preferably, the content of the first chelating agent is 30 g/L to 60 g/L, and the content of the second chelating agent is 5 g/L to 80 g/L.

According to the basic electroless nickel plating solution operated at low temperature of the present invention, the source of the nickel ion is preferably selected from the group consisting of: nickel chloride, nickel sulfate, nickel methane sulfonate, nickel aminosulfonate, and a combination thereof. The content of the nickel ion is preferably 4.5 g/L to 10.0 g/L, or is equivalent to 20-45 g/L in the form of nickel sulfate hexahydrate, 18-40 g/L in the form of nickel chloride hexahydrate, 19-42.5 g/L in the form of nickel methane sulfonate, or 24.5-55 g/L in the form of nickel aminosulfonate (tetrahydrate).

According to the basic electroless nickel plating solution operated at low temperature of the present invention, the reducing agent is preferably selected from the group consisting of: sodium hypophosphite, ammonium hypophosphite, phosphinic acid, hydrazine, dimethylamine borane (DMAB), sodium borohydride (SBH), diethylamine borane, morpholine borane, and a combination thereof. When the reducing agent is DMAB, SBH, diethylamine borane, or morpholine borane, the content of the reducing agent is 0.5 g/L to 20 g/L, preferably. When the reducing agent is sodium hypophosphite, ammonium hypophosphite, phosphinic acid, or hydrazine, the content of the reducing agent is preferably 5 g/L to 40 g/L, more preferably 5 g/L to 30 g/L.

Preferably, the basic electroless nickel plating solution operated at low temperature of the present invention may further comprise a buffering agent, which can be selected from the group consisting of: ammonium chloride, ammonium sulfate, boric acid, acetic acid, propanoic acid, oxalic acid, succinic acid, lactic acid, glycolic acid, tartaric acid, and a combination thereof. Preferably, the content of the buffering agent is 1 g/L to 20 g/L.

Preferably, the basic electroless nickel plating solution operated at low temperature of the present invention may further comprise 2 g/L to 12 g/L of an accelerating agent, which may be selected from the group consisting of: hydrofluoric acid (HF), sodium fluoride (NaF), potassium fluoride (KF), ammonium fluoride (NH₄F), and a combination thereof.

Preferably, the basic electroless nickel plating solution operated at low temperature of the present invention may further comprise 0.0005 g/L to 0.002 g/L of a stabilizer, which may be selected from the group consisting of: thiourea; derivatives of thiourea; thiocyanate; acetic compounds of Pb²⁺, Sb³⁺, and Bi³⁺; nitric compounds of Pb²⁺, Sb³⁺, and Bi³⁺; and water-soluble organic material with —SH group.

Preferably, the basic electroless nickel plating solution operated at low temperature of the present invention may further comprise a surfactant.

Preferably, the basic electroless nickel plating solution operated at low temperature of the present invention may further comprise a stress relieving agent, which may be saccharin.

According to the basic electroless nickel plating solution operated at low temperature of the present invention, the term of “basic” means that the pH value of the electroless nickel plating solution is in a range of 7.0 to 14.0, preferably in a range of 7.0 to 10.0, more preferably in a range of 7.0 to 9.4, and most preferably in a range of 7.6 to 9.0. In addition, the term of “low temperature” means that the temperature for performing electroless nickel plating process with the basic electroless nickel plating solution of the present invention is in a range of 40° C. to 80° C., which is lower than the temperature for performing electroless nickel plating process with conventional electroless nickel plating solution (85° C.).

According to the basic electroless nickel plating solution operated at low temperature of the present invention, the pH adjusting agent may be selected from the group consisting of: ammonia, sodium hydroxide (NaOH), potassium hydroxide (KOH), or a combination thereof.

Even without performing any activation process, when the basic electroless nickel plating solution operated at low temperature of the present invention is used to plate nickel for an electrode of a solar cell, nickel can be plated on the surface of silicon and not be plated on the surface of silicon nitride. Hence, the basic electroless nickel plating solution of the present invention has excellent selectivity between silicon nitride and silicon. However, an acidic electroless nickel plating solution does not have such selectivity between silicon nitride and silicon.

If a basic electroless nickel plating solution having pH value over 10.0 or containing too much chloride ion is used for the electroless plating of a positive electrode comprising aluminum layer (e.g. a back surface filed layer, BSF layer) for a solar cell, the aluminum layer of the positive electrode may be corroded. Therefore, the pH value of the electroless nickel plating solution of the present invention is preferably in a range of 7.0 to 10.0, more preferably in a range of 7.0 to 9.4, and most preferably in a range of 7.6 to 9.0, and the content of the chloride ion is less than 1000 ppm, in order to prevent the aluminum layer from being corroded.

Hence, the present invention further provides a basic electroless nickel plating solution operated at low temperature for electroless plating to give a positive electrode comprising aluminum layer, wherein the basic electroless nickel plating solution is used to form an electrode of a solar cell having patterned structure comprising silicon and silicon nitride. The electroless nickel plating solution of the present invention comprises: (a) nickel ions; (b) a reducing agent; (c) a first chelating agent selected from the group consisting of citric acid, ammonium citrate, sodium citrate, potassium citrate, and a mixture thereof; (d) a second chelating agent; (e) a stabilizer; and (f) water, wherein the pH value of the electroless nickel plating solution is in a range of 7.0 to 10.0; the content of the chloride ion is less than 1000 ppm; the second chelating agent is one selected from the group consisting of: alkylol amine (i.e. alcohol amine), ethylene diamine, diethylene triamine, triethylene tetramine, and a combination thereof.

The basic electroless nickel plating solution of the present invention has high selectivity between silicon nitride and silicon. Hence, nickel can be plated on the surface of silicon, and not plated on the surface of silicon nitride. When the electroless nickel plating solution of the present invention is applied on an aluminum layer to provide a positive electrode of a solar cell, the electroless nickel plating solution does not corrode the aluminum layer, and nickel can be plated on the surface of the aluminum layer. Therefore, the basic electroless nickel plating solution of the present invention is very suitable for forming electrodes on a aluminum layer of a solar cell, and a positive electrode and a negative electrode of a solar cell can be formed separately or simultaneously.

According to the present invention, in order to enable nickel to be plated on the surface of silicon, and not plated on the surface of silicon nitride, it is necessary to lower the plating temperature. Also, in order to achieve the purpose of performing the low temperature process, the sorts and the ratio of the chelating agents have to be adjusted properly to meet the requirement for start of the electroless nickel plating reaction. In addition, the sorts of the chelating agents may influence the lifespan of the electroless nickel plating solution.

According to the basic electroless nickel plating solution operated at low temperature of the present invention, the alkylol amine (i.e. alcohol amine) is preferably selected from the group consisting of: diethanol amine, triethanol amine, and mixtures thereof.

According to the basic electroless nickel plating solution operated at low temperature of the present invention, the content of the nickel ion is preferably 4.5 g/L to 10.0 g/L, the content of the first chelating agent is preferably 30 g/L to 60 g/L, the content of the second chelating agent is preferably 5 g/L to 80 g/L, and the content of the stabilizer is preferably 0.0005 g/L to 0.002 g/L.

According to the basic electroless nickel plating solution operated at low temperature of the present invention, the source of the nickel ion is preferably selected from the group consisting of: nickel chloride, nickel sulfate, nickel methane sulfonate, nickel aminosulfonate, and a combination thereof. The content of the nickel ion is preferably 4.5 g/L to 10.0 g/L, or is equivalent to 20-45 g/L in the form of nickel sulfate hexahydrate, 18-40 g/L in the form of nickel chloride hexahydrate, 19-42.5 g/L in the form of nickel methane sulfonate, or 24.5-55 g/L in the form of nickel aminosulfonate (tetrahydrate).

According to the basic electroless nickel plating solution operated at low temperature of the present invention, the reducing agent is preferably selected form the group consisting of: sodium hypophosphite, ammonium hypophosphite, phosphinic acid, hydrazine, dimethylamine borane (DMAB), sodium borohydride (SBH), diethylamine borane, morpholine borane, and a combination thereof. When the reducing agent is DMAB, SBH, diethylamine borane, or morpholine borane, the content of the reducing agent is 0.5 g/L to 20 g/L, preferably. When the reducing agent is sodium hypophosphate, ammonium hypophosphite, phosphinic acid, or hydrazine, the content of the reducing agent is preferably 5 g/L to 40 g/L, more preferably 5 g/L to 30 g/L.

Preferably, the basic electroless nickel plating solution operated at low temperature of the present invention may further comprise a buffering agent, which can be selected from the group consisting of: ammonium chloride, ammonium sulfate, boric acid, acetic acid, propanoic acid, oxalic acid, succinic acid, lactic acid, glycolic acid, tartaric acid, and a combination thereof. Preferably, the content of the buffering agent is 1 g/L to 20 g/L.

Preferably, the basic electroless nickel plating solution operated at low temperature of the present invention may further comprise an accelerating agent, which may be selected from the group consisting of: hydrofluoric acid (HF), sodium fluoride (NaF), potassium fluoride (KF), ammonium fluoride (NH₄F), and a combination thereof, and the content of the accelerating agent is preferably 2 g/L to 12 g/L.

According to the basic electroless nickel plating solution operated at low temperature of the present invention, the stabilizer may be preferably selected from the group consisting of: thiourea; derivatives of thiourea; thiocyanate; acetic compounds of Pb²⁺, Sb³⁺, and Bi³⁺; nitric compounds of Pb²⁺, Sb³⁺, and Bi³⁺; and water-soluble organic material with —SH group, and more preferably thiourea or compounds of Pb²⁺. Besides, the content of the stabilizer may be 0.0005 g/L to 0.002 g/L.

Preferably, the basic electroless nickel plating solution operated at low temperature of the present invention may further comprise a surfactant.

Preferably, the basic electroless nickel plating solution operated at low temperature of the present invention may further comprise a stress relieving agent, which may be saccharin.

According to the basic electroless nickel plating solution operated at low temperature of the present invention, the term of “basic” means that the pH value of the electroless nickel plating solution is in a range of 7.0 to 14.0, preferably in a range of 7.0 to 10.0, more preferably in a range of 7.0 to 9.4, and most preferably in a range of 7.6 to 9.0.

In addition, the term of “low temperature” means that the temperature for performing electroless nickel plating process with the basic electroless nickel plating solution of the present invention is in a range of 40° C. to 80° C., which is lower than the temperature for performing electroless nickel plating process with conventional electroless nickel plating solution (85° C.). The basic electroless nickel plating solution of the present invention is preferably operated at a temperature of 40° C. to 80° C.

According to the basic electroless nickel plating solution operated at low temperature of the present invention, a pH adjusting agent may be needed to adjust the pH value of the basic electroless nickel plating solution, the pH adjusting agent may be selected from the group consisting of: ammonia, sodium hydroxide (NaOH), potassium hydroxide (KOH), or a combination thereof.

Moreover, in another situation when a P-type silicon surface is electroless plated to give a positive electrode, the using of the basic electroless nickel plating solution comprising the first and second reducing agents of the present invention may satisfy (1) high selectivity between silicon nitride and silicon; (2) high plating uniformity of the positive electrode; and (3) positive and negative electrode-plating at the same time. If a conventional nickel plating solution is used, some disadvantages may incur such as (a) low selectivity between silicon nitride and silicon; and (b) low plating uniformity of the positive electrode, and thus electrode with unsatisfied performance may be provided.

The basic electroless nickel plating solution comprising the first and second reducing agents of the present invention, which is used to form an electrode of a solar cell having patterned structure comprising silicon and silicon nitride, can be operated at low temperature. The electroless nickel plating solution of the present invention comprises: (a) nickel ions; (b) a first reducing agent, which is selected from the group consisting of sodium hypophosphate, ammonium hypophosphite, phosphinic acid, and a mixture thereof; (c) a second reducing agent, which is borane; (d) a first chelating agent selected from the group consisting of citric acid, ammonium citrate, sodium citrate, potassium citrate, and a mixture thereof; (e) a second chelating agent; (f) a stabilizer; and (g) water, wherein the pH value of the electroless nickel plating solution is in a range of 7.0 to 10.0; the second chelating agent is one selected from the group consisting of: alkylol amine (i.e. alcohol amine), ethylene diamine, diethylene triamine, triethylene tetramine, and a combination thereof.

According to the basic electroless nickel plating solution operated at low temperature of the present invention, the alkylol amine (i.e. alcohol amine) is preferably selected from the group consisting of: diethanol amine, triethanol amine, and mixtures thereof.

According to the basic electroless nickel plating solution operated at low temperature of the present invention, the source of the nickel ion is preferably selected from the group consisting of: nickel chloride, nickel sulfate, nickel methane sulfonate, nickel aminosulfonate, and a combination thereof. The content of the nickel ion is preferably 4.5 g/L to 10.0 g/L, or is equivalent to 20-45 g/L in the form of nickel sulfate hexahydrate, 18-40 g/L in the form of nickel chloride hexahydrate, 19-42.5 g/L in the form of nickel methane sulfonate, or 24.5-55 g/L in the form of nickel aminosulfonate (tetrahydrate).

According to the basic electroless nickel plating solution operated at low temperature of the present invention, the content of the nickel ion is preferably 4.5 g/L to 10.0 g/L, the content of the first reducing agent may preferably be 5 g/L to 30 g/L, the content of the second reducing agent may preferably be 0.5 g/L to 20 g/L, the content of the first chelating agent is preferably 30 g/L to 60 g/L, the content of the second chelating agent is preferably 5 g/L to 80 g/L, and the content of the stabilizer is preferably 0.0005 g/L to 0.002 g/L. Besides, according to the basic electroless nickel plating solution of the present invention, the content of the second reducing agent may more preferably be 1 g/L to 15 g/L.

According to the basic electroless nickel plating solution of the present invention, the second reducing agent is preferably selected form the group consisting of: sodium borohydride (SBH), dimethylamine borane (DMAB), diethylamine borane, morpholine borane, and a combination thereof.

Preferably, the basic electroless nickel plating solution of the present invention may further comprise a buffering agent, which can be selected from the group consisting of: ammonium sulfate, boric acid, acetic acid, propanoic acid, oxalic acid, succinic acid, lactic acid, glycolic acid, tartaric acid, and a combination thereof.

Preferably, the content of the buffering agent is 1 g/L to 20 g/L.

Preferably, the basic electroless nickel plating solution of the present invention may further comprise an accelerating agent, which may be selected from the group consisting of: hydrofluoric acid (HF), sodium fluoride (NaF), potassium fluoride (KF), ammonium fluoride (NH₄F), and a combination thereof.

Preferably, the content of the accelerating agent is 2 g/L to 12 g/L.

According to the basic electroless nickel plating solution of the present invention, the stabilizer may be preferably selected from the group consisting of: thiourea; derivatives of thiourea; thiocyanate; acetic compounds of Pb²⁺, Sb³⁺, and Bi³⁺; nitric compounds of Pb²⁺, Sb³⁺, and Bi³⁺; and water-soluble organic material with —SH group.

Preferably, the basic electroless nickel plating solution of the present invention may further comprise a surfactant.

Preferably, the basic electroless nickel plating solution of the present invention may further comprise a stress relieving agent, which may be saccharin.

According to the basic electroless nickel plating solution of the present invention, the term of “basic” means that the pH value of the electroless nickel plating solution is in a range of 7.0 to 14.0, preferably in a range of 7.0 to 10.0, more preferably in a range of 7.0 to 9.4, and most preferably in a range of 7.6 to 9.0. In addition, the term of “low temperature” means that the temperature for performing electroless nickel plating process with the basic electroless nickel plating solution of the present invention is in a range of 40° C. to 80° C., which is lower than the temperature for performing electroless nickel plating process with conventional electroless nickel plating solution (85° C.).

According to the basic electroless nickel plating solution of the present invention, a pH adjusting agent may be needed to adjust the pH value of the basic electroless nickel plating solution, the pH adjusting agent may be selected from the group consisting of: ammonia, sodium hydroxide (NaOH), potassium hydroxide (KOH), or a combination thereof.

The basic electroless nickel plating solution operated at low temperature of the present invention may be used for providing solar cell, and the method may comprises:

Step 1: providing a silicon substrate;

Step 2: pre-treatment to the silicon substrate (an optional step); and

Step 3: forming electrodes by using the basic electroless nickel plating solution of the present invention.

In the present method, the electroless nickel plating process is performed in a range of 40° C. to 80° C., preferably. In addition, the pH value of the electroless nickel plating solution is in a range of preferably 7.0 to 10.0, more preferably 7.0 to 9.4, most preferably 7.6 to 9.0. When an aluminum layer is disposed on the solar cell, the concentration of the chloride ion is preferably less than 1000 ppm, and the pH value of the electroless nickel plating solution is preferably in a range of 7.6 to 9.0. If the pH value is higher than 9.0, the electroless nickel plating solution may corrode the aluminum layer slightly. If the pH value is higher than 10.0, the electroless nickel plating solution may corrode the aluminum layer severely. Hence, the electroless nickel plating solution used in the method of the present invention is in a range of 7.6 to 9.0 preferably. In this case, the electroless nickel plating solution may perform its selectivity between silicon nitride and silicon, and is not harmful to the aluminum layer. Hence, it is possible to plate Ni on the aluminum layer.

Specifically, the method of forming electrodes of a solar cell of the present invention may comprise the following steps of 1 to 3, wherein the step 2 is an optional step.

(Step 1) A silicon substrate is provided, wherein the silicon substrate has a first surface and a second surface, and the first surface is a patterned surface comprising silicon and silicon nitride. The patterned surface may be a plane surface comprising silicon and silicon nitride, a surface with elevation difference comprising silicon and silicon nitride in the micro-scale, or a texture surface comprising silicon and silicon nitride. Preferably, the patterned surface is one comprising silicon and silicon nitride, as shown in FIG. 2A. Recesses 4 form in the silicon nitride layer 3 and in the first surface 21, the recesses 4 extend through the silicon nitride layer 3 to expose the silicon surface 25 of the silicon layer 23, and an aluminum layer 6 locates on a second surface 22. In addition, the silicon surface 25 may be a layer consisting of single crystal silicon, polycrystal silicon, microcrystal silicon, amorphous silicon, nano-sized single crystal silicon, or nano-sized polycrystal silicon.

(Step 2) The silicon substrate is pre-treated before an electroless nickel plating process.

(Step 3) The electroless nickel plating process is performed. The silicon substrate 2 is dipped in an electroless nickel plating solution to perform the electroless nickel plating process, and a negative electrode and a positive electrode are formed on the silicon surface 25 of the recess 4 and on the aluminum layer 6 respectively.

As shown in FIG. 2B, a nickel layer 51 is formed on the silicon surface 25 of the recess 4, and a nickel layer 52 is formed on the aluminum layer 6, after the steps 1-3 are completed. Therefore, the electrodes of the solar cell are obtained.

According to the method of forming electrodes of a solar cell by an electroless nickel plating process of the present invention, the first surface may have an n-type silicon layer, and the second surface may have a p-type silicon layer, preferably.

In the present method, in the step 1, the second surface 22 may be a silicon surface without an aluminum layer being formed thereon, as shown in FIG. 3A. After the steps 2 and 3 are completed, a nickel layer 51 is formed on the silicon surface 25 of the first surface 21, and a nickel layer 52 is formed on the silicon layer 26 of the second surface 22 of the, as shown in FIG. 3B. The second surface 22 may be a layer consisting of single crystal silicon, polycrystal silicon, microcrystal silicon, amorphous silicon, nano-sized single crystal silicon, or nano-sized polycrystal silicon.

In the present method, in the step 1, the second surface is a patterned surface consisting of silicon and silicon oxide, silicon and silicon nitride, silicon and silicon oxynitride, silicon and organic polymer, or silicon and photoresist layer. As shown in FIG. 4A, a layer 31 containing recesses 5 is disposed on the second surface 22, and the recesses 5 extend through the layer 31 to expose the surface 26 from the recesses 5. The surface 26 may be a layer consisting of single crystal silicon, polycrystal silicon, microcrystal silicon, amorphous silicon, nano-sized single crystal silicon, or nano-sized polycrystal silicon. After the steps 1 to 3 are completed, a nickel layer 51 is formed on the silicon surface 25 exposed by the recess 4, and a nickel layer 52 is formed on the surface 26 exposed by the recess 5, as shown in FIG. 4B. In addition, the layer 31 can be a silicon oxide layer, a silicon nitride layer, a silicon oxynitride layer, an organic polymer layer, a photoresist layer, or a combination thereof. For example, the organic polymer layer may be a polyimide layer.

Further, in the present method, in the step 1, a patterned surface may further locate on the second surface, wherein the patterned surface consists of an aluminum layer and a silicon oxide layer, an aluminum layer and a silicon nitride layer, an aluminum layer and a silicon oxynitride layer, an aluminum layer and an organic polymer layer, or an aluminum layer and a photoresist layer. As shown in FIG. 5A, the layer 31 with the recesses 5 and an aluminum layer 7 formed in the recesses 5 are located on the second surface 22. After the steps 2 to 3 are completed, a nickel layer 51 is formed in the recess 4 (i.e. on the silicon surface 25), and a nickel layer 52 is formed on the aluminum layer 7, as shown in FIG. 5B. In addition, the layer 31 can be a silicon oxide layer, a silicon nitride layer, a silicon oxynitride layer, an organic polymer layer, a photoresist layer, or a combination thereof.

Besides, in the present method, in the step 1, if it is not desired to plate Ni on the aluminum layer 6 (as shown in FIG. 2A) or on the second surface 22, a silicon oxide layer, a silicon nitride layer, a silicon oxynitride layer, an organic polymer layer, or a photoresist layer is disposed on the aluminum layer or on the second surface. As shown in FIG. 6A, in the case of a silicon substrate without an aluminum layer, a layer 32 is disposed on the second surface 22, wherein the layer 32 may be a silicon oxide layer, a silicon nitride layer, a silicon oxynitride layer, an organic polymer layer, a photoresist layer, or a combination thereof. After the steps 2 to 3 are completed, a nickel layer 51 is only formed in the recess 4 (i.e. on the silicon surface 25), as shown in FIG. 6B. Then, the layer 32 is removed through a conventional semiconductor manufacturing process. For example, the layer 32 can be removed by an organic solvent, a stripper, an etching solution, ionic plasma, or super critical fluid, as shown in FIG. 6C.

Besides, in the present method, if it is desired to plate Ni on the second surface 22 and on the patterned surface consisting of silicon and silicon nitride sequentially, a layer 33 of an organic polymer layer or a photoresist layer can be first formed on the patterned surface consisting of silicon and silicon nitride, as shown in FIG. 7B. Next, the second surface 22 is plated by use of the basic electroless nickel plating solution operated at low temperature of the present invention, as shown in FIG. 7C. Then, the layer 33 of the organic polymer layer or the photoresist layer is removed by use of an organic solvent or a stripper, as shown in FIG. 7D, and a nickel layer 52 is formed on the second surface 22 of the solar cell. Finally, a negative electrode 51 is formed on the solar cell by use of the basic electroless nickel plating solution through the steps 2 and 3, as shown in FIG. 7E.

Besides, in the present method, a silicon substrate 2 shown in FIG. 8A can be used in the step 1. As shown in FIG. 8A, a silicon substrate 2 is provided, wherein recesses 4 are formed in the silicon nitride layer 3 and the first surface 21, and the recesses 4 extend through the silicon nitride layer 3 to expose the silicon surface 25 of the silicon layer 23. Also, recesses 5 are formed in the layer 31 of silicon oxide, silicon nitride, silicon oxynitride and the second surface 22, and the recesses 5 penetrate the layer 31 to expose the surface 26 of the silicon layer 24. Then, nano-sized silicon particles containing n-type dopants are formed in the recesses 4, and nano-sized silicon particles containing p-type dopants are formed in the recesses 5, through a coating process or an inkjet printing process. After a sintering process, an n-type nano-sized silicon particle layer 71 and a p-type nano-sized silicon particle layer 72 are formed in the recesses 4 and the recesses 5 respectively, as shown in FIG. 8B. Finally, the steps 2 and 3 of the electroless nickel plating process are performed by use of the basic electroless nickel plating solution operated at low temperature of the present invention, and nickel layers 51, 52 are formed on the n-type nano-sized silicon particle layer 71 and the p-type nano-sized silicon particle layer 72 respectively.

In the present method, the pre-treatment before the electroless nickel plating process can be: removing silicon oxide on the surface of the silicon substrate by use of HF; or activating the silicon substrate with a PdCl₂ solution or an AuCl₂.HCl.nH₂O solution.

### BRIEF DESCRIPTION OF THE DRAWINGS

FIGS. 1A-1C are cross-sectional views illustrating a conventional process for forming electrodes of a solar cell; and

FIGS. 2A-2B, 3A-3B, 4A-4B, 5A-5B, 6A-6C, 7A-7E, and 8A-8C are cross-sectional views illustrating processes for forming electrodes of a solar cell by use of the method of forming electrodes of a solar cell by an electroless nickel plating process of the present invention.

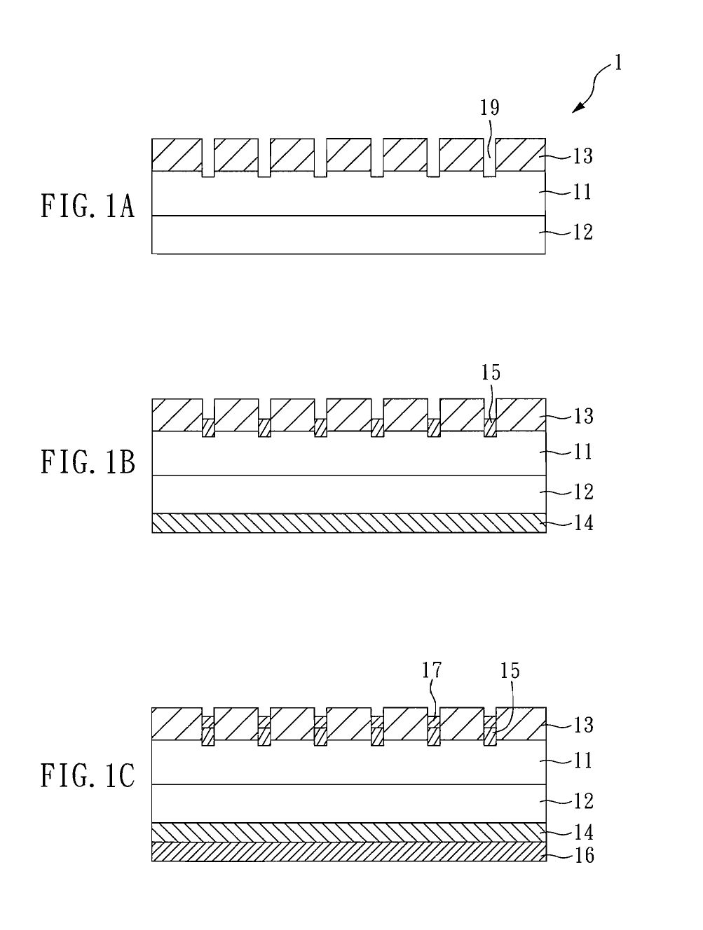

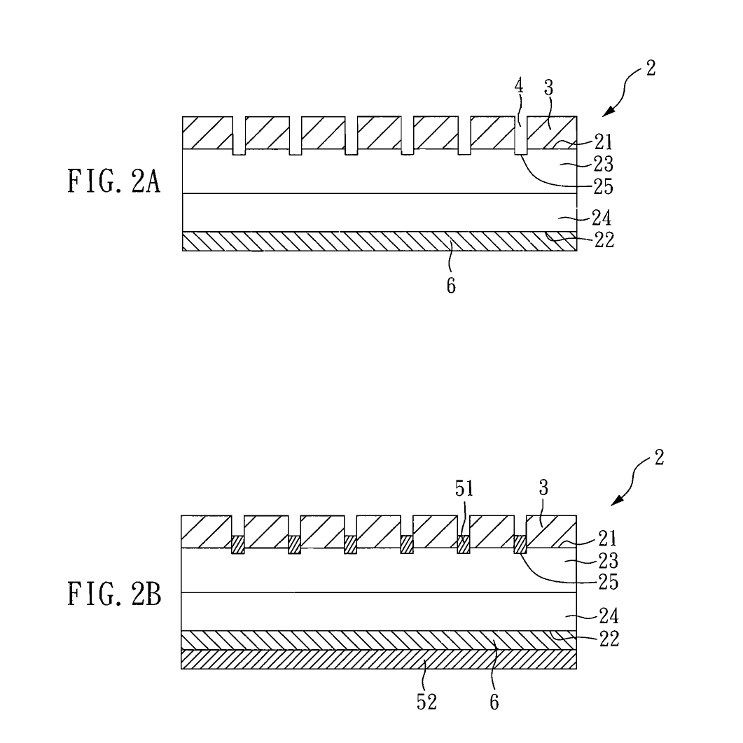

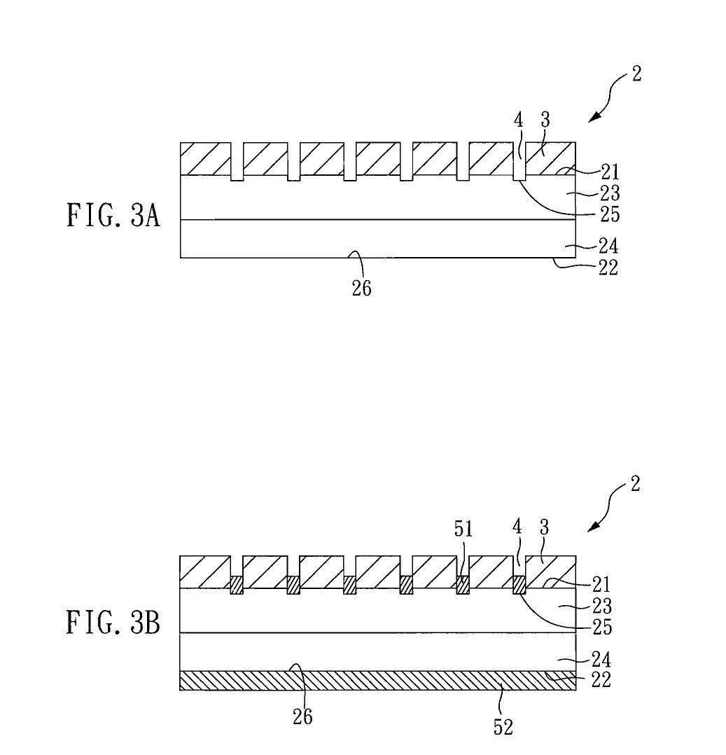

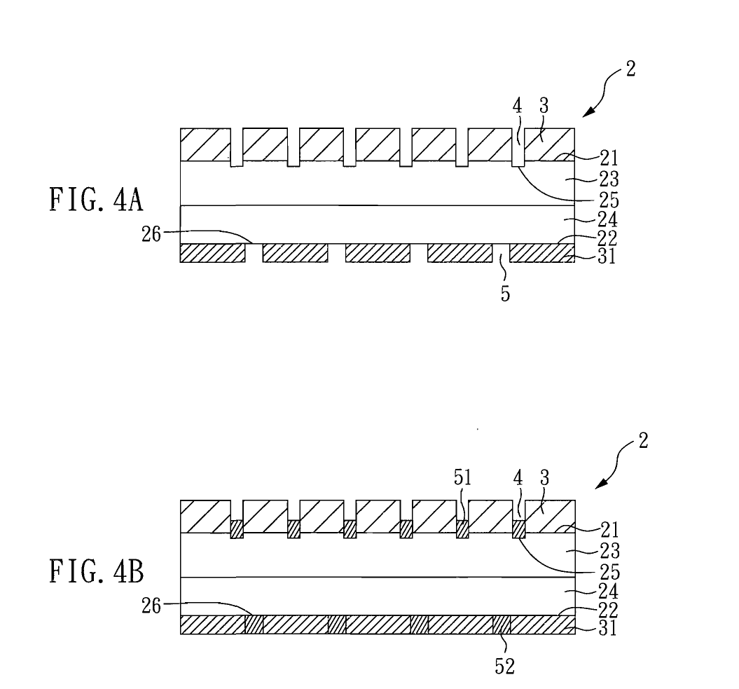

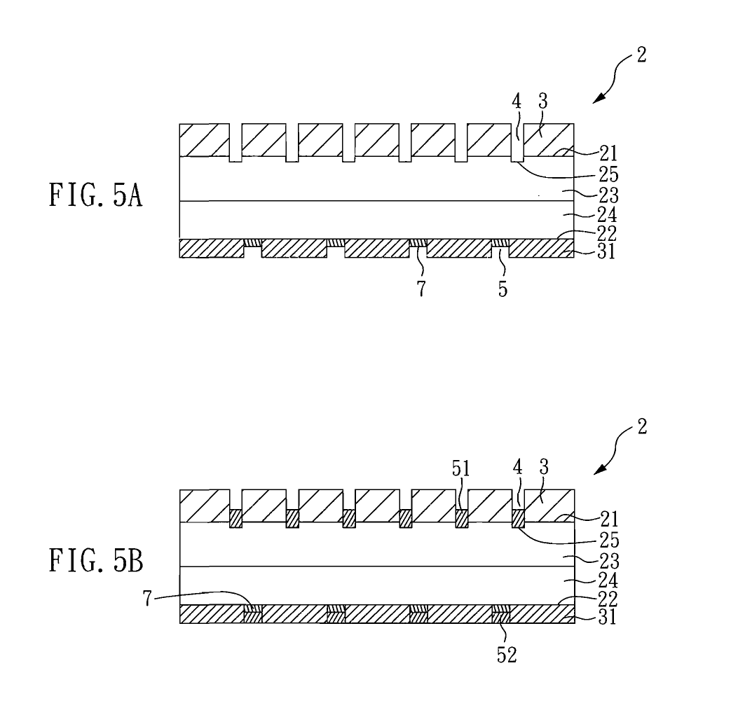

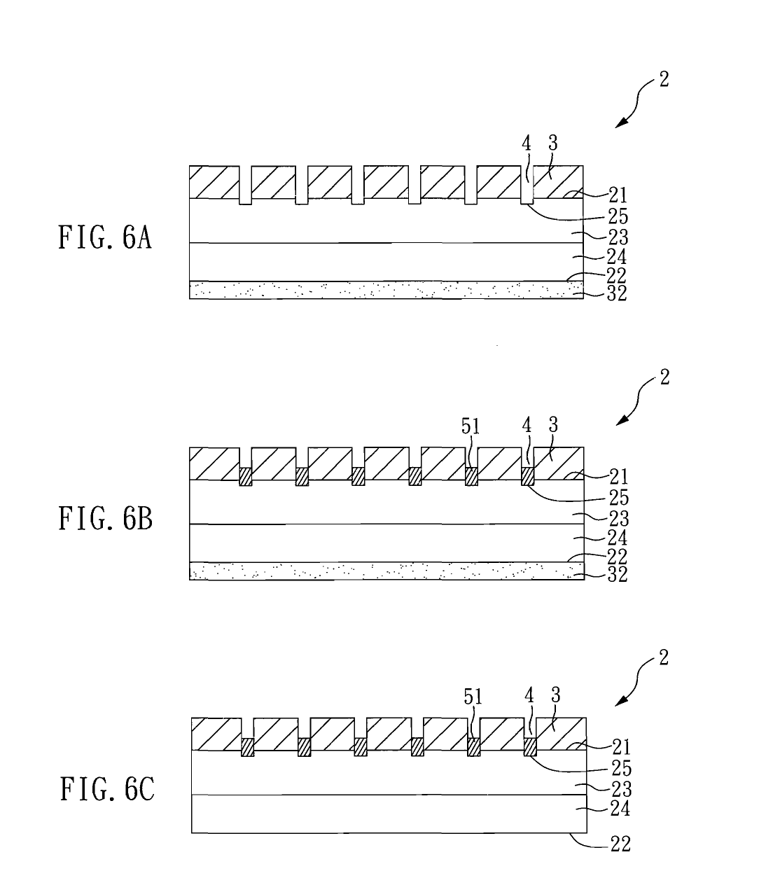

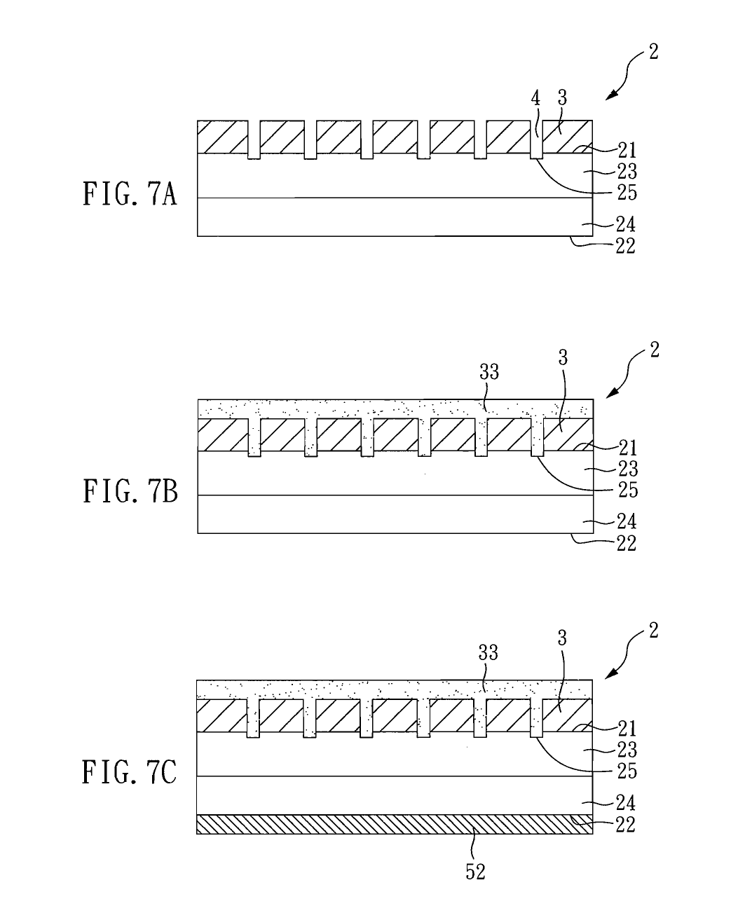

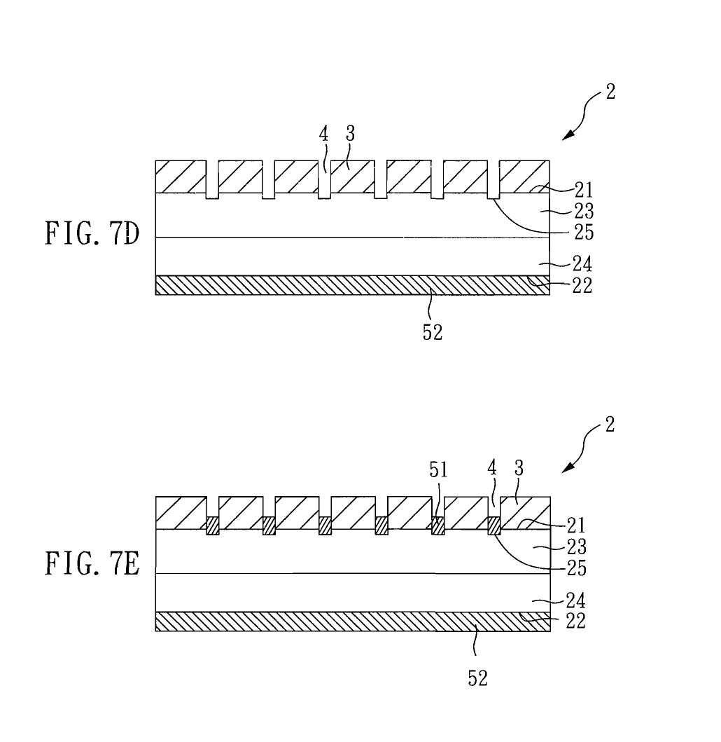

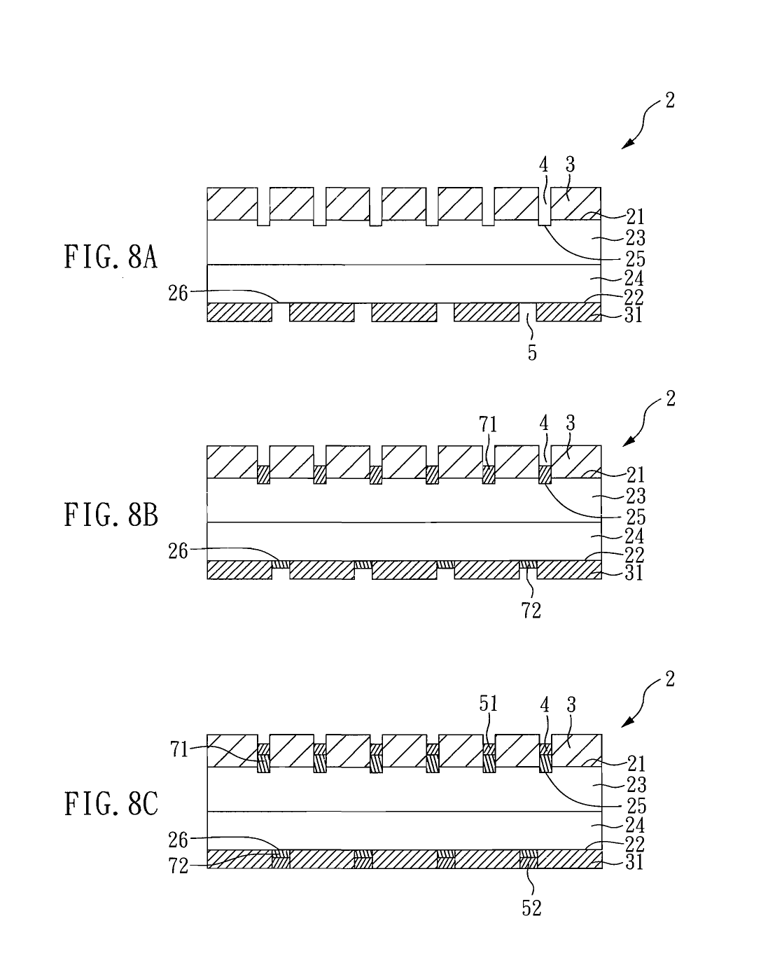

### DETAILED DESCRIPTION OF THE PREFERRED EMBODIMENT

Because of the specific embodiments illustrating the practice of the present invention, a person having ordinary skill in the art can easily understand other advantages and efficiency of the present invention through the content disclosed therein. The present invention can also be practiced or applied by other variant embodiments. Many other possible modifications and variations of any detail in the present specification based on different outlooks and applications can be made without departing from the spirit of the invention.

### Example 1

The electroless nickel plating solution of the present example is prepared with the composition of: 34 g/L of nickel sulfate; 18 g/L of sodium hypophosphate; 50 g/L of ammonium citrate; 8 g/L of ammonium chloride; 10 g/L of triethanolamine; 4 g/L of sodium fluoride; and 0.0009 g/L of thiourea. Besides, the pH value of the electroless nickel plating solution is adjusted to about 7.5 to 8.2.

### Example 2

The electroless nickel plating solution of the present example is prepared with the composition of: 34 g/L of nickel chloride; 7 g/L of DMAB (dimethylamine borane); 50 g/L of ammonium citrate; 8 g/L of ammonium chloride; 60 g/L of triethanolamine; 8 g/L of sodium fluoride; 0.001 g/L of thiourea; and 1 g/L of saccharin. Besides, the pH value of the electroless nickel plating solution is adjusted to about 8.0 to 9.0.

### Example 3

The electroless nickel plating solution of the present example is prepared with the composition of: 35 g/L of nickel sulfate; 15 g/L of sodium hypophosphite; 5 g/L of DMAB (dimethylamine borane); 40 g/L of ammonium citrate; 5 g/L of ammonium sulfate; 20 g/L of triethanolamine; 6 g/L of sodium fluoride; and 0.001 g/L of Pb²⁺. Besides, the pH value of the electroless nickel plating solution is adjusted to about 8.0 to 8.5.

### Example 4

The electroless nickel plating solution of the present example is prepared with the composition of: 35 g/L of nickel sulfate; 25 g/L of sodium hypophosphite; 1.25 g/L of DMAB (dimethylamine borane); 55 g/L of ammonium citrate; 13 g/L of ammonium sulfate; 40 g/L of triethanolamine; 5 g/L of sodium fluoride; and 0.001 g/L of Pb²⁺. Besides, the pH value of the electroless nickel plating solution is adjusted to about 8.5 to 9.3.

From the experimental results, it is shown that the operating temperature of the electroless nickel plating solution of examples 1 to 4 is from 50° C. to 70° C. The electroless nickel plating solution of the present invention has high selectivity between silicon nitride and silicon, and therefore enables nickel to be plated on the surface of silicon and not to be plated on the surface of silicon nitride. Therefore, the electroless nickel plating solution of the present invention is suitable for being used in the fabrication of the electrodes of the solar cell.

### Comparative Example 1

The electroless nickel plating solution of the present comparative example is prepared with the composition of: 30 g/L of nickel sulfate; 10 g/L of sodium hypophosphite; 65 g/L of ammonium citrate; 50 g/L of ammonium chloride; and 0.001 g/L of Pb²⁺. Besides, the pH value of the electroless nickel plating solution is adjusted to about 8.2 to 8.8.

The electroless nickel plating solution of the present comparative example is a conventional electroless nickel plating solution, which cannot be started to process nickel plating on the surface of silicon below the temperature of 86° C.

From the experimental results, it is shown that the electroless nickel plating solution of the comparative example 1 has less selectivity between silicon nitride and silicon than that of the examples 1 to 4. Moreover, the electroless nickel plating solution of the comparative example 1 is harmful to the aluminum layer. The surface of the aluminum layer after being treated with the electroless nickel plating solution of the comparative example 1 becomes rough and shows some traces of corrosion caused by the electroless nickel plating solution.

Although the present invention has been explained in relation to its preferred embodiment, it is to be understood that many other possible modifications and variations can be made without departing from the spirit and scope of the invention as hereinafter claimed.

What is claimed is:

1. A basic electroless nickel plating solution for forming an electrode of a solar cell having patterned structure comprising silicon and silicon nitride, comprising:
(a) 4.5 g/L to 10.0 g/L of nickel ions;
(b) a reducing agent;
(c) 30 g/L to 60 g/L of a first chelating agent selected from the group consisting of citric acid, ammonium citrate, sodium citrate, potassium citrate, and a mixture thereof;
(d) 5 g/L to 80 g/L of a second chelating agent;
(e) 0.0005 g/L to 0.002 g/L of a stabilizer; and
(f) water,
wherein the pH value of the electroless nickel plating solution is in a range of 7.0 to 10.0; the second chelating agent is one selected from the group consisting of: alkylol amine, ethylene diamine, diethylene triamine, triethylene tetramine, and a combination thereof.

2. The basic electroless nickel plating solution as claimed in claim 1, wherein the alkylol amine is selected from the group consisting of: diethanol amine, triethanol amine, and mixtures thereof.

3. The basic electroless nickel plating solution as claimed in claim 1, wherein the reducing agent is selected from the group consisting of: sodium borohydride, dimethylamine borane, diethylamine borane, morpholine borane, and a combination thereof, and the content of the reducing agent is 0.5 to 20 g/L.

4. The basic electroless nickel plating solution as claimed in claim 1, wherein the reducing agent is selected form: sodium hypophosphite, ammonium hypophosphite, phosphinic acid, hydrazine, and the content of the reducing agent is 5 to 40 g/L.

5. The basic electroless nickel plating solution as claimed in claim 1, further comprising a buffering agent selected from the group consisting of: ammonium chloride, ammonium sulfate, boric acid, acetic acid, propanoic acid, oxalic acid, succinic acid, lactic acid, glycolic acid, tartaric acid, and a combination thereof.

6. The basic electroless nickel plating solution as claimed in claim 5, wherein the content of the buffering agent is 1 g/L to 20 g/L.

7. The basic electroless nickel plating solution as claimed in claim 1, further comprising an accelerating agent selected from the group consisting of: hydrofluoric acid, sodium fluoride, potassium fluoride, ammonium fluoride, and a combination thereof.

8. The basic electroless nickel plating solution as claimed in claim 7, wherein the content of the accelerating agent is 2 g/L to 12 g/L.

9. The basic electroless nickel plating solution as claimed in claim 1, wherein the stabilizer is selected from the group consisting of: thiourea; derivatives of thiourea; thiocyanate; acetic compounds of Pb²⁺, Sb³⁺, and Bi³⁺; nitric compounds of Pb²⁺, Sb³⁺, and Bi³⁺; and water-soluble organic material having —SH group.

10. A basic electroless nickel plating solution for forming an electrode of a solar cell having patterned structure comprising silicon and silicon nitride, comprising:
(a) nickel ions;
(b) a reducing agent;
(c) a first chelating agent selected from the group consisting of citric acid, ammonium citrate, sodium citrate, potassium citrate, and a mixture thereof;
(d) a second chelating agent;
(e) a stabilizer; and
(f) water,
wherein the pH value of the electroless nickel plating solution is in a range of 7.0 to 10.0; the content of the chloride ion is less than 1000 ppm; the second chelating agent is one selected from the group consisting of: alkylol amine, ethylene diamine, diethylene triamine, triethylene tetramine, and a combination thereof.

11. The basic electroless nickel plating solution as claimed in claim 10, wherein the alkylol amine is preferably selected from the group consisting of: diethanol amine, triethanol amine, and mixtures thereof.

12. The basic electroless nickel plating solution as claimed in claim 10, wherein the content of the nickel ion is 4.5 g/L to 10.0 g/L, the content of the first chelating agent is 30 g/L to 60 g/L, the content of the second chelating agent is 5 g/L to 80 g/L, and the content of the stabilizer is 0.0005 g/L to 0.002 g/L.

13. The basic electroless nickel plating solution as claimed in claim 10, wherein reducing agent is selected form the group consisting of:
sodium borohydride, dimethylamine borane, diethylamine borane, morpholine borane, and a combination thereof, and the content of the reducing agent is 0.5 to 20 g/L.

14. The basic electroless nickel plating solution as claimed in claim 10, wherein the reducing agent is selected form the group consisting of: sodium hypophosphite, ammonium hypophosphite, phosphinic acid, hydrazine, and the content of the reducing agent is 5 to 40 g/L.

15. The basic electroless nickel plating solution as claimed in claim 10, further comprising a buffering agent selected from the group consisting of: ammonium chloride, ammonium sulfate, boric acid, acetic acid, propanoic acid, oxalic acid, succinic acid, lactic acid, glycolic acid, tartaric acid, and a combination thereof.

16. The basic electroless nickel plating solution as claimed in claim 15, wherein the content of the buffering agent is 1 g/L to 20 g/L.

17. The basic electroless nickel plating solution as claimed in claim 10, further comprising an accelerating agent selected from the group consisting of: hydrofluoric acid, sodium fluoride, potassium fluoride, ammonium fluoride, and a combination thereof.

18. The basic electroless nickel plating solution as claimed in claim 17, wherein the content of the accelerating agent is 2 g/L to 12 g/L.

19. The basic electroless nickel plating solution as claimed in claim 10, wherein the stabilizer is selected from the group consisting of thiourea; derivatives of thiourea; thiocyanate; acetic compounds of Pb²⁺, Sb³⁺, and Bi³⁺; nitric compounds of Pb²⁺, Sb³⁺, and Bi³⁺; and water-soluble organic material having —SH group.

20. A basic electroless nickel plating solution for forming an electrode of a solar cell having patterned structure comprising silicon and silicon nitride, comprising:
(a) nickel ions;
(b) a first reducing agent, which is selected from the group consisting of sodium hypophosphate, ammonium hypophosphite, phosphinic acid, and a mixture thereof;
(c) a second reducing agent, which is borane;
(d) a first chelating agent selected from the group consisting of citric acid, ammonium citrate, sodium citrate, potassium citrate, and a mixture thereof;
(e) a second chelating agent;
(f) a stabilizer; and
(g) water,
wherein the pH value of the electroless nickel plating solution is in a range of 7.0 to 10.0; the second chelating agent is one selected from the group consisting of: alkylol amine, ethylene diamine, diethylene triamine, triethylene tetramine, and a combination thereof.

21. The basic electroless nickel plating solution as claimed in claim 20, wherein the alkylol amine is preferably selected from the group consisting of: diethanol amine, triethanol amine, and mixtures thereof.

22. The basic electroless nickel plating solution as claimed in claim 20, wherein the content of the nickel ion is 4.5 g/L to 10.0 g/L, the content of the first reducing agent is 5 g/L to 30 g/L, the content of the second reducing agent is 0.5 g/L to 20 g/L, the content of the first chelating agent is 30 g/L to 60 g/L, the content of the second chelating agent is 5 g/L to 80 g/L, and the content of the stabilizer is 0.0005 g/L to 0.002 g/L.

23. The basic electroless nickel plating solution as claimed in claim 20, wherein the second reducing agent is selected form the group consisting of: sodium borohydride, dimethylamine borane, diethylamine borane, morpholine borane, and a combination thereof.

24. The basic electroless nickel plating solution as claimed in claim 20, further comprising a buffering agent selected from the group consisting of: ammonium sulfate, boric acid, acetic acid, propanoic acid, oxalic acid, succinic acid, lactic acid, glycolic acid, tartaric acid, and a combination thereof.

25. The basic electroless nickel plating solution as claimed in claim 24, wherein the content of the buffering agent is 1 g/L to 20 g/L.

26. The basic electroless nickel plating solution as claimed in claim 20, further comprising an accelerating agent selected from the group consisting of: hydrofluoric acid, sodium fluoride, potassium fluoride, ammonium fluoride, and a combination thereof.

27. The basic electroless nickel plating solution as claimed in claim 26, wherein the content of the accelerating agent is 2 g/L to 12 g/L.

28. The basic electroless nickel plating solution as claimed in claim 20, wherein the stabilizer is selected from the group consisting of thiourea; derivatives of thiourea; thiocyanate; acetic compounds of Pb²⁺, Sb³⁺, and Bi³⁺; nitric compounds of Pb²⁺, Sb³⁺, and Bi³⁺; and water-soluble organic material having —SH group.
